(19) United States
(12) Patent Application Publication
(10) Pub. No.: US 2014/0323298 A1
(43) Pub. Date: Oct. 30, 2014

(54) HERBICIDAL COMPOSITIONS COMPRISING OXYFLUORFEN AND HALOXYFOP

(71) Applicant: Dow AgroSciences LLC, Indianapolis, IN (US)

(72) Inventors: Daniel Fernando Ovalle Orjuela, Bogota (CO); Orlando Aguilar, Bogota (CO); Paola Luciana Mautong Plaza, Guayaquil (EC); Richard K. Mann, Franklin, IN (US); Roger E. Gast, Zionsville, IN (US)

(73) Assignee: Dow AgroSciences LLC, Indianapolis, IN (US)

(21) Appl. No.: 14/135,352

(22) Filed: Dec. 19, 2013

Related U.S. Application Data
(60) Provisional application No. 61/740,344, filed on Dec. 20, 2012.

(51) Int. Cl. A01N 43/40; A01N 33/22

(52) U.S. Cl. CPC A01N 43/40; A01N 33/22
USPC 504/103; 504/130

(57) ABSTRACT

An herbicidal composition containing (a) oxyfluorfen and (b) haloxyfop or an agriculturally acceptable ester or salt thereof provides control of undesirable vegetation, e.g., in crops, including but not limited to direct-seeded, water-seeded and transplanted rice, wheat, barley, oats, rye, sorghum, corn/maize, cotton, pastures, grasslands, rangelands, fallowland, turf, tree and vine orchards, including, but not limited to, citrus, grapes and tree nuts, aquatics, vegetables (e.g., onions, shallots, peppers, tomatoes, artichokes, cole crops, guava, papaya and strawberries), industrial vegetation management, deciduous trees, conifers, perennial crops and plantation crops (including, but not limited to, coffee and palm oil) and rights of way.

### CROSS REFERENCE TO RELATED APPLICATIONS

This application claims the benefit of U.S. Provisional Patent Application Ser. No. 61/740,344, filed Dec. 20, 2012, the disclosure of which is expressly incorporated herein by reference.

### FIELD

Provided herein are synergistic herbicidal compositions comprising (a) oxyfluorfen and (b) haloxyfop or an agriculturally acceptable ester or salt thereof. Provided herein are also methods of controlling undesirable vegetation, particularly in crops, comprising applying (a) oxyfluorfen and (b) haloxyfop or an agriculturally acceptable ester or salt thereof.

### BACKGROUND

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. However, there remains a need for additional compositions and methods that are effective in controlling undesirable vegetation.

### SUMMARY

Provided herein are synergistic herbicidal compositions which unexpectedly provide increased control of undesirable vegetation and which comprise a herbicidally effective amount of (a) oxyfluorfen and (b) haloxyfop or an agriculturally acceptable ester or salt thereof. The compositions may also contain an agriculturally acceptable adjuvant or carrier.

Also provided herein are methods of controlling undesirable vegetation in, for example, crops, including but not limited to rice, wheat, barley, oats, rye, sorghum, soybean, green bean, garbanzo bean, corn/maize, cotton, pastures, grasslands, rangelands, fallowland, fallow-bed prior to planting crops, tree, vine and fruit orchards, including, but not limited to, citrus, grapes, almond, apple, apricot, avocado, beechnut, Brazil nut, butternut, cashew, cherry, chestnut, chinquapin, crab apple, date, feijoa, fig, filbert, hickory nut, kiwi, loquat, macadamia nut, mayhaws, nectarine, olives, peach, pear, pecan, persimmon, pistachio, plum, pomegranates, prune, quince, and walnut; vegetables (e.g., onions, onions grown for seed, shallots, garlic, peppers, tomatoes, artichokes and cole crops); fruiting crops (e.g., blueberries, guava, papaya, strawberries, taro, blackberries and raspberries); perennial crops, plantation crops (including, but not limited to, coffee, cacao, rubber and palm oil) and non-crop (including turf, forestry, aquatics, industrial vegetation management (IVM), deciduous trees, conifers (seedbeds, transplants, container stock and plantations/windbreaks), fencerows, parking areas, tank farm and storage areas, rights-of-way and utility areas), comprising applying (a) oxyfluorfen and (b) haloxyfop or an agriculturally acceptable ester or salt thereof.

### DETAILED DESCRIPTION

### Definitions

As used herein, and unless otherwise indicated, herbicide means a compound, e.g., an active ingredient that kills, controls or otherwise adversely modifies the growth of undesirable plants.

As used herein, and unless otherwise indicated, a herbicidally effective or vegetation controlling amount is an amount of active ingredient which causes an adversely modifying effect to the vegetation e.g., causing deviations from natural development, killing, effecting regulation, causing desiccation, causing retardation, and the like.

As used herein, and unless otherwise indicated, controlling undesirable vegetation means preventing, reducing, killing, or otherwise adversely modifying the development of plants and vegetation. Described herein are methods of controlling undesirable vegetation through the application of certain herbicide combinations or compositions. Methods of application include, but are not limited to applications to the vegetation or locus thereof, e.g., application to the area adjacent to the vegetation, as well as pre-emergence, post-emergence, foliar, burn-down, and in-water applications.

As used herein, and unless otherwise indicated, plants and vegetation include, but are not limited to, germinant seeds, emerging seedlings, plants emerging from vegetative propagules, immature vegetation, and mature established vegetation.

As used herein, and unless otherwise indicated, agriculturally acceptable salts and esters refer to salts and esters that exhibit herbicidal activity, or that are or can be converted in plants, water, or soil to the referenced herbicide. Exemplary agriculturally acceptable esters are those that are or can by hydrolyzed, oxidized, metabolized, or otherwise converted, e.g., in plants, water, or soil, to the corresponding carboxylic acid which, depending on the pH, may be in the dissociated or undissociated form.

As used herein, and unless otherwise indicated, oxyfluorfen is 2-chloro-1-(3-ethoxy-4-nitrophenoxy)-4-(trifluoromethyl)benzene and possesses the following structure:

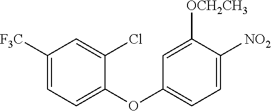 [SMILES: CCOc1cc(Oc2ccc(C(F)(F)F)cc2Cl)ccc1[N+](=O)[O-]]

Its herbicidal activity is exemplified in Tomlin, C. D. S., Ed. The Pesticide Manual: A World Compendium, 15^{th} ed.; BCPC: Alton, 2009 (hereafter “The Pesticide Manual, Fifteenth Edition, 2009”). Exemplary uses of oxyfluorfen include pre- or post-emergence control of annual broadleaf weeds and grasses in temperate, tropical and subtropical crops.

As used herein, and unless otherwise indicated, haloxyfop is (±)-2-[4-[[3-chloro-5-(trifluoromethyl)-2-pyridinyl]oxy]phenoxy]propanoic acid and possesses the following structure:

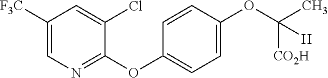 [SMILES: CC(Oc1ccc(Oc2ncc(C(F)(F)F)cc2Cl)cc1)C(=O)O]

As used herein, and unless otherwise indicated, haloxyfop also refers to an enantiomer of (±)-2-[4-[[3-chloro-5-(trifluoromethyl)-2-pyridinyl]oxy]phenoxy]propanoic acid, or a mixture of enantiomers thereof. In one embodiment, haloxyfop refers to (R)-(+)-2-[4-[[3-chloro-5-(trifluoromethyl)-2-pyridinyl]oxy]phenoxy]propanoic acid, which is also commonly known as haloxyfop-P. In another embodiment, haloxyfop refers to (S)-(−)-2-[4-[[3-chloro-5-(trifluoromethyl)-2-pyridinyl]oxy]phenoxy]propanoic acid.

As used herein, and unless otherwise indicated, an agriculturally acceptable ester or salt of haloxyfop encompasses all of the agriculturally acceptable esters or salts of haloxyfop known in the art or provided herein. In one embodiment, the agriculturally acceptable salt of haloxyfop is a sodium salt (e.g., haloxyfop-sodium). In one embodiment, the agriculturally acceptable ester of haloxyfop is a methyl ester (e.g., haloxyfop-methyl or haloxyfop-P-methyl) or a 2-ethoxyethyl (etotyl) ester (e.g., haloxyfop-etotyl or haloxyfop-P-etotyl).

The herbicidal activity of haloxyfop or an agriculturally acceptable ester or salt thereof is exemplified in The Pesticide Manual, Fifteenth Edition, 2009. Exemplary uses of haloxyfop include post-emergence control of annual and perennial grasses in sugar beet, fodder beet, oilseed rape, potatoes, leaf vegetables, onions, flax, sunflowers, soybeans, vines, strawberries, rice and other crops.

As used herein, and unless otherwise indicated, the term “about,” when used in connection with amounts, weight ratios, weight percentages, or application rates of ingredients of a composition means that an amount, a weight ratio, a weight percentage, or an application rate that is recognized by those of ordinary skill in the art to provide a herbicidal effect equivalent to that obtained from the specified amount, weight ratio, weight percentage, or application rate is encompassed. Specifically, the term “about” contemplates an amount, a weight ratio, or an application rate within 30%, 25%, 20%, 15%, 10%, or 5% of the specified amount, weight ratio, weight percentage, or application rate.

### Compositions and Methods

Provided herein are herbicidal compositions comprising a herbicidally effective amount of (a) oxyfluorfen and (b) haloxyfop or an agriculturally acceptable ester or salt thereof which unexpectedly provides synergistic control of undesirable vegetation. In one embodiment, the herbicidal composition comprises a herbicidally effective amount of (a) oxyfluorfen and (b) haloxyfop. In one embodiment, the herbicidal composition comprises a herbicidally effective amount of (a) oxyfluorfen and (b) an agriculturally acceptable salt of haloxyfop. In one embodiment, the agriculturally acceptable salt is a sodium salt. In another embodiment, the herbicidal composition comprises a herbicidally effective amount of (a) oxyfluorfen and (b) an agriculturally acceptable ester of haloxyfop. In one embodiment, the agriculturally acceptable ester is a methyl ester (e.g., haloxyfop-methyl or haloxyfop-P-methyl) or an etotyl ester (e.g., haloxyfop-etotyl or haloxyfop-P-etotyl). In one embodiment, the agriculturally acceptable ester is the (R)- or (S)-enantiomer of the methyl ester (e.g., haloxyfop-methyl or haloxyfop-P-methyl) or an etotyl ester (e.g., haloxyfop-etotyl or haloxyfop-P-etotyl). In one embodiment, the agriculturally acceptable ester is a methyl ester.

In certain embodiments, provided herein are herbicidal compositions comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:2 to about 50:1; from about 1:1 to about 10:1; from about 2:1 to about 10:1; from about 10:1 to about 30:1; from about 10:1 to about 20:1; or from about 5:1 to about 20:1. In certain embodiments, the weight ratio of oxyfluorfen to haloxyfop or an agriculturally acceptable ester or salt thereof is within the range of from about 1:3 to about 100:1. In certain embodiments, the weight ratio of oxyfluorfen to haloxyfop or an agriculturally acceptable ester or salt thereof is within the range of from about 3:1 to about 9:1. In one embodiment, the weight ratio of oxyfluorfen to haloxyfop or an agriculturally acceptable ester or salt thereof is about 8.6:1. In another embodiment, the weight ratio of oxyfluorfen to haloxyfop or an agriculturally acceptable ester or salt thereof is about 5.7:1. In yet another embodiment, the weight ratio of oxyfluorfen to haloxyfop or an agriculturally acceptable ester or salt thereof is about 2.9:1.

In certain embodiments, provided herein are herbicidal compositions comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:1 to about 50:1; from about 2:1 to about 30:1; from about 3:1 to about 10:1; from about 3:1 to about 9:1; from about 10:1 to about 30:1; from about 10:1 to about 20:1; or from about 5:1 to about 20:1. In certain embodiments, the weight ratio of oxyfluorfen to haloxyfop or an agriculturally acceptable ester or salt thereof is within the range of from about 1:3 to about 100:1. In certain embodiments, the weight ratio of oxyfluorfen to haloxyfop or an agriculturally acceptable ester or salt thereof is within the range of from about 3:1 to about 9:1. In one embodiment, the weight ratio of oxyfluorfen to haloxyfop or an agriculturally acceptable ester or salt thereof is about 2.9:1 to about 8.6:1.

Also provided herein are methods of controlling undesirable vegetation comprising contacting the vegetation or the locus thereof (i.e., area adjacent to the vegetation) with, or applying to the soil or water to prevent the emergence or growth of vegetation, a herbicidally effective amount of (a) oxyfluorfen and (b) haloxyfop, or an agriculturally acceptable ester or salt thereof. In one embodiment, provided herein are methods of controlling undesirable vegetation comprising contacting the vegetation or the locus thereof (i.e., area adjacent to the vegetation) with, or applying to the soil or water to prevent the emergence or growth of vegetation, a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:2 to about 50:1; from about 1:1 to about 10:1; from about 2:1 to about 10:1; from about 10:1 to about 30:1; from about 10:1 to about 20:1; or from about 5:1 to about 20:1. In one embodiment, provided herein are methods of controlling undesirable vegetation comprising contacting the vegetation or the locus thereof (i.e., area adjacent to the vegetation) with, or applying to the soil or water to prevent the emergence or growth of vegetation, a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:1 to about 50:1; from about 2:1 to about 30:1; from about 3:1 to about 10:1; from about 3:1 to about 9:1; from about 10:1 to about 30:1; from about 10:1 to about 20:1; or from about 5:1 to about 20:1. In certain embodiments, the weight ratio of oxyfluorfen to haloxyfop or an agriculturally acceptable ester or salt thereof is within the range of from about 1:3 to about 100:1. In certain embodiments, the weight ratio of oxyfluorfen to haloxyfop or an agriculturally acceptable ester or salt thereof is within the range of from about 3:1 to about 9:1. In one embodiment, the weight ratio of oxyfluorfen to haloxyfop or an agriculturally acceptable ester or salt thereof is about 8.6:1. In another embodiment, the weight ratio of oxyfluorfen to haloxyfop or an agriculturally acceptable ester or salt thereof is about 5.7:1. In yet another embodiment, the weight ratio of oxyfluorfen to haloxyfop or an agriculturally acceptable ester or salt thereof is about 2.9:1.

In certain embodiments, the methods employ the compositions described herein. In certain embodiments, provided herein are methods of controlling undesirable vegetation comprising contacting the vegetation or the locus thereof (i.e., area adjacent to the vegetation) with, or applying to the soil or water to prevent the emergence or growth of vegetation, a herbicidal composition comprising a herbicidally effective amount of (a) oxyfluorfen and (b) haloxyfop, or an agriculturally acceptable ester or salt thereof. In one embodiment, provided herein are methods of controlling undesirable vegetation comprising contacting the vegetation or the locus thereof (i.e., area adjacent to the vegetation) with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof wherein the weight ratio of oxyfluorfen to haloxyfop or an agriculturally acceptable ester or salt thereof is within the range of: from about 1:3 to about 200:1; from about 1:2 to about 100:1; from about 1:2 to about 50:1; from about 1:1 to about 10:1; from about 2:1 to about 10:1; from about 10:1 to about 30:1; from about 10:1 to about 20:1; or from about 5:1 to about 20:1. In one embodiment, provided herein are methods of controlling undesirable vegetation comprising contacting the vegetation or the locus thereof (i.e., area adjacent to the vegetation) with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof wherein the weight ratio of oxyfluorfen to haloxyfop or an agriculturally acceptable ester or salt thereof is within the range of: from about 1:3 to about 200:1; from about 1:2 to about 100:1; from about 1:1 to about 50:1; from about 2:1 to about 10:1; from about 3:1 to about 10:1; from about 3:1 to about 9:1, from about 10:1 to about 30:1; from about 10:1 to about 20:1; or from about 5:1 to about 20:1. In certain embodiments, the weight ratio of oxyfluorfen to haloxyfop or an agriculturally acceptable ester or salt thereof is within the range of from about 1:3 to about 100:1. In certain embodiments, the weight ratio of oxyfluorfen to haloxyfop or an agriculturally acceptable ester or salt thereof is within the range of from about 3:1 to about 9:1. In one embodiment, the weight ratio of oxyfluorfen to haloxyfop or an agriculturally acceptable ester or salt thereof is about 8.6:1. In another embodiment, the weight ratio of oxyfluorfen to haloxyfop or an agriculturally acceptable ester or salt thereof is about 5.7:1. In yet another embodiment, the weight ratio of oxyfluorfen to haloxyfop or an agriculturally acceptable ester or salt thereof is about 2.9:1.

Furthermore, in some embodiments, the combination of (a) oxyfluorfen and (b) haloxyfop or an agriculturally acceptable ester or salt thereof exhibits synergism, e.g., the herbicidal active ingredients are more effective in combination than when applied individually. Accordingly, provided herein in some embodiments is a synergistic herbicidal composition comprising a herbicidally effective amount of (a) oxyfluorfen and (b) haloxyfop, or an agriculturally acceptable ester or salt thereof. Synergism has been defined as “an interaction of two or more factors such that the effect when combined is greater than the predicted effect based on the response of each factor applied separately.” Senseman, S., Ed. Herbicide Handbook, 9^{th} ed. Lawrence: Weed Science Society of America, 2007. In certain embodiments, the compositions exhibit synergy as determined by the Colby equation (Colby, S. R. Calculation of the synergistic and antagonistic response of herbicide combinations. Weeds 1967, 15, 20-22).

In some embodiments, oxyfluorfen and haloxyfop or an agriculturally acceptable ester or salt thereof are formulated in one composition, tank mixed, applied simultaneously, or applied sequentially. In some embodiments of the methods described herein, oxyfluorfen and haloxyfop or an agriculturally acceptable ester or salt thereof are applied simultaneously, including, e.g., in the form of a composition. In some embodiments, the components are applied sequentially, e.g., within 5, 10, 15, or 30 minutes of each other; 1, 2, 3, 4, 5, 10, 12, 24, 48 hour(s) of each other, or 1 week of each other.

Herbicidal activity is exhibited by the compounds when they are applied directly to the plant or to the locus of the plant at any stage of growth. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. In some embodiments, the compositions described herein are applied as a post-emergence application, pre-emergence application, or in-water application to flooded paddy rice or water bodies (e.g., ponds, lakes and streams), to relatively immature undesirable vegetation to achieve the maximum control of weeds.

In some embodiments, the compositions and methods provided herein are utilized to control weeds in crops, including but not limited to direct-seeded, water-seeded and transplanted rice, wheat, barley, oats, rye, sorghum, soybean, green bean, garbanzo bean, corn/maize, cotton, pastures, grasslands, rangelands, fallowland, fallow-bed prior to planting crops, tree, vine and fruit orchards, including, but not limited to, citrus, grapes, almond, apple, apricot, avocado, beechnut, Brazil nut, butternut, cashew, cherry, chestnut, chinquapin, crab apple, date, feijoa, fig, filbert, hickory nut, kiwi, loquat, macadamia nut, mayhaws, nectarine, olives, peach, pear, pecan, persimmon, pistachio, plum, pomegranates, prune, quince, and walnut; vegetables (e.g., onions, onions grown for seed, shallots, garlic, peppers, tomatoes, artichokes and cole crops); fruiting crops (e.g., blueberries, guava, papaya, strawberries, taro, blackberries and raspberries); perennial crops, plantation crops (including, but not limited to, coffee, cacao, rubber and palm oil) and non-crop (including turf, forestry, aquatics, industrial vegetation management (IVM), deciduous trees, conifers (seedbeds, transplants, container stock and plantations/windbreaks), fencerows, parking areas, tank farm and storage areas, rights-of-way and utility areas).

In certain embodiments, the compositions and methods provided herein are utilized to control weeds in rice. In certain embodiments, the rice is direct-seeded, water-seeded, or transplanted rice. In other embodiments, the compositions and methods provided herein are utilized to control weeds in vegetable crops, including onion, onion grown for seed, garlic, shallots, peppers, tomatoes, artichokes, cole crops, guava, pineapple, papaya and strawberry crops. In other embodiments, the compositions and methods provided herein are utilized to control weeds in onion crops.

The compositions and methods described herein be used to control undesirable vegetation on glyphosate-tolerant-, glufosinate-tolerant-, dicamba-tolerant-, phenoxy auxin-tolerant-, pyridyloxy auxin-tolerant-, aryloxyphenoxypropionate-tolerant-, acetyl CoA carboxylase (ACCase) inhibitor-tolerant-, imidazolinone-tolerant-, acetolactate synthase (ALS) inhibitor-tolerant-, 4-hydroxyphenyl-pyruvate dioxygenase (HPPD) inhibitor-tolerant-, protoporphyrinogen oxidase (PPO) inhibitor-tolerant-, triazine-tolerant-, bromoxynil-tolerant-crops (such as, but not limited to, soybean, cotton, canola/oilseed rape, rice, cereals, corn/maize, turf, etc.), for example, in conjunction with glyphosate, glufosinate, dicamba, phenoxy auxins, pyridyloxy auxins, aryloxyphenoxypropionates, ACCase inhibitors, imidazolinones, ALS inhibitors, HPPD inhibitors, PPO inhibitors, triazines, and bromoxynil The compositions and methods may be used in controlling undesirable vegetation in crops possessing multiple or stacked traits conferring tolerance to multiple chemistries and/or inhibitors of multiple modes of action. In some embodiments, oxyfluorfen and haloxyfop or an agriculturally acceptable ester or salt thereof are used in combination with herbicides that are selective for the crop being treated and which complement the spectrum of weeds controlled by these compounds at the application rate employed. In some embodiments, the compositions described herein and other complementary herbicides are applied at the same time, either as a combination formulation or as a tank mix.

In certain embodiments, the compositions and methods provided herein are utilized to control undesirable vegetation. Undesirable vegetation includes, but is not limited to, undesirable vegetation that occurs in rice, vegetables including but not limited to onions, shallots, peppers, tomatoes and strawberries, cereals, range and pasture, row crops (e.g., corn/maize, soybean, cotton, canola/oilseed rape), fallow-bed prior to planting crops, fruiting crops (e.g., blueberries, blackberries and raspberries), pome, stone and citrus trees, tree nut, vines, and ornamental species, aquatic and non-crop settings (e.g., turf, forestry, aquatics, industrial vegetation management (IVM), deciduous trees, conifers (seedbeds, transplants, container stock and plantations/windbreaks), fencerows, parking areas, tank farm and storage areas, rights-of-way and utility areas).

In some embodiments, the methods provided herein are utilized to control undesirable vegetation in vegetables including but not limited to onions, garlic, shallots, peppers, tomatoes, artichokes, cole crops, guava, pineapple, papaya, and strawberries. In some embodiments, the methods provided herein are utilized to control undesirable vegetation in onions and onions grown for seed. In some embodiments, the methods provided herein are utilized to control undesirable vegetation in onions. In certain embodiments, the undesirable vegetation is common ragweed, hairy beggarticks, birdsrape mustard, smallflower galinsoga, goosegrass, poison ryegrass, annual bluegrass and bristly foxtail.

In certain embodiments, also provided herein are methods of controlling undesirable vegetation in onion comprising contacting the vegetation or the locus thereof (i.e., area adjacent to the vegetation) with, or applying to the soil or water to prevent the emergence or growth of vegetation, a herbicidally effective amount of (a) oxyfluorfen and (b) haloxyfop or an agriculturally acceptable ester or salt thereof. In one embodiment, provided herein are methods of controlling undesirable vegetation in onion comprising contacting the vegetation or the locus thereof (i.e., area adjacent to the vegetation) with, or applying to the soil or water to prevent the emergence or growth of vegetation, a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:2 to about 50:1; from about 1:1 to about 10:1; from about 2:1 to about 10:1; from about 10:1 to about 30:1; from about 10:1 to about 20:1; or from about 5:1 to about 20:1. In one embodiment, provided herein are methods of controlling undesirable vegetation in onion comprising contacting the vegetation or the locus thereof (i.e., area adjacent to the vegetation) with, or applying to the soil or water to prevent the emergence or growth of vegetation, a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:1 to about 50:1; from about 2:1 to about 10:1; from about 3:1 to about 10:1; from about 3:1 to about 9:1, from about 10:1 to about 30:1; from about 10:1 to about 20:1; or from about 5:1 to about 20:1. In certain embodiments, the weight ratio of oxyfluorfen to haloxyfop or an agriculturally acceptable ester or salt thereof is within the range of from about 1:3 to about 100:1. In certain embodiments, the weight ratio of oxyfluorfen to haloxyfop or an agriculturally acceptable ester or salt thereof is within the range of from about 3:1 to about 9:1. In one embodiment, the weight ratio of oxyfluorfen to haloxyfop or an agriculturally acceptable ester or salt thereof is about 8.6:1. In another embodiment, the weight ratio of oxyfluorfen to haloxyfop or an agriculturally acceptable ester or salt thereof is about 5.7:1. In yet another embodiment, the weight ratio of oxyfluorfen to haloxyfop or an agriculturally acceptable ester or salt thereof is about 2.9:1.

In certain embodiments, provided herein are methods of controlling undesirable vegetation in onion comprising contacting the vegetation or the locus thereof (i.e., area adjacent to the vegetation) with, or applying to the soil to prevent the emergence or growth of vegetation, a herbicidal composition comprising a herbicidally effective amount of (a) oxyfluorfen and (b) haloxyfop or an agriculturally acceptable ester or salt thereof. In one embodiment, provided herein are methods of controlling undesirable vegetation in onion comprising contacting the vegetation or the locus thereof (i.e., area adjacent to the vegetation) with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:2 to about 50:1; from about 1:1 to about 10:1; from about 2:1 to about 10:1; from about 10:1 to about 30:1; from about 10:1 to about 20:1; or from about 5:1 to about 20:1. In one embodiment, provided herein are methods of controlling undesirable vegetation in onion comprising contacting the vegetation or the locus thereof (i.e., area adjacent to the vegetation) with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is within the range of: from about 1:3 to about 200:1; from about 1:2 to about 100:1; from about 1:1 to about 50:1; from about 2:1 to about 10:1; from about 3:1 to about 10:1; from about 3:1 to about 9:1; from about 10:1 to about 30:1; from about 10:1 to about 20:1; or from about 5:1 to about 20:1. In certain embodiments, the weight ratio of oxyfluorfen to haloxyfop or an agriculturally acceptable ester or salt thereof is within the range of from about 1:3 to about 100:1. In certain embodiments, the weight ratio of oxyfluorfen to haloxyfop or an agriculturally acceptable ester or salt thereof is within the range of from about 3:1 to about 9:1. In one embodiment, the weight ratio of oxyfluorfen to haloxyfop or an agriculturally acceptable ester or salt thereof is about 8.6:1. In another embodiment, the weight ratio of oxyfluorfen to haloxyfop or an agriculturally acceptable ester or salt thereof is about 5.7:1. In yet another embodiment, the weight ratio of oxyfluorfen to haloxyfop or an agriculturally acceptable ester or salt thereof is about 2.9:1.

In some embodiments, the methods provided herein are utilized to control undesirable vegetation in rice. In certain embodiments, the undesirable vegetation is Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Panicum dichotomiflorum (L.) Michx. (fall panicum, PANDI), Paspalum dilatatum Poir. (dallisgrass, PASDI), Cyperus difformis L. (smallflower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SPCJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindernia dubia (L.) Pennell (low false pimpernel, LIDDU), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (POLHP, mild smartweed), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

In some embodiments, the methods provided herein are utilized to control undesirable vegetation in cereals. In certain embodiments, the undesirable vegetation is Alopecurus myosuroides Huds. (blackgrass, ALOMY), Apera spica-venti (L.) Beauv. (windgrass, APESV), Avena fatua L. (wild oat, AVEFA), Bromus tectorum L. (downy brome, BROTE), Lolium multiflorum Lam. (Italian ryegrass, LOLMU), Phalaris minor Retz. (littleseed canarygrass, PHAMI), Poa annua L. (annual bluegrass, POANN), Setaria pumila (Poir.) Roemer & J. A. Schultes (yellow foxtail, SETLU), Setaria viridis (L.) Beauv. (green foxtail, SETVI), Cirsium arvense (L.) Scop. (Canada thistle, CIRAR), Galium aparine L. (catchweed bedstraw, GALAP), Kochia scoparia (L.) Schrad. (kochia, KCHSC), Lamium purpureum L. (purple deadnettle, LAMPU), Matricaria recutita L. (wild chamomile, MATCH), Matricaria matricarioides (Less.) Porter (pineappleweed, MATMT), Papaver rhoeas L. (common poppy, PAPRH), Polygonum convolvulus L. (wild buckwheat, POLCO), Salsola tragus L. (Russian thistle, SASKR), Stellaria media (L.) Vill. (common chickweed, STEME), Veronica persica Poir. (Persian speedwell, VERPE), Viola arvensis Murr. (field violet, VIOAR), or Viola tricolor L. (wild violet, VIOTR).

In some embodiments, the methods provided herein are utilized to control undesirable vegetation in range and pasture. In certain embodiments, the undesirable vegetation is Ambrosia artemisiifolia L. (common ragweed, AMBEL), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Sida spinosa L. (prickly sida, SIDSP), Sinapis arvensis L. (wild mustard, SINAR), Sonchus arvensis L. (perennial sowthistle, SONAR), Solidago species (goldenrod, SOOSS), Taraxacum officinale G. H. Weber ex Wiggers (dandelion, TAROF), Trifolium repens L. (white clover, TRFRE), or Urtica dioica L. (common nettle, URTDI).

In some embodiments, the methods provided herein are utilized to control undesirable vegetation found in vegetable and row crops. In certain embodiments, the undesirable vegetation is Alopecurus myosuroides Huds. (blackgrass, ALOMY), Avena fatua L. (wild oat, AVEFA), Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Lolium multiflorum Lam. (Italian ryegrass, LOLMU), Panicum dichotomiflorum Michx. (fall panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Asclepias syriaca L. (common milkweed, ASCSY), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carona L. (wild carrot, DAUCA), Euphorbia heterophylla L. (wild poinsettia, EPHHL), Erigeron bonariensis L. (hairy fleabane, ERIBO), Erigeron canadensis L. (Canadian fleabane, ERICA), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Sida spinosa L. (prickly sida, SIDSP), Sinapis arvensis L. (wild mustard, SINAR), Solanum ptychanthum Dunal (eastern black nightshade, SOLPT), or Xanthium strumarium L. (common cocklebur, XANST).

In some embodiments, the compositions and methods provided herein are utilized to control undesirable vegetation, including grass, broadleaf and sedge weeds in onions and other vegetable, row crop, tree crop, plantation crop and non-crop areas. In certain embodiments, the compositions and methods provided herein are utilized to control undesirable vegetation including but not limited to common ragweed (Ambrosia artemisiifolia L., AMBEL), birdsrape mustard (Brassica rapa, BRSRA), goosegrass (Eleusine indica, ELEIN), annual bluegrass (Poa annua, POAAN), bristly foxtail (Setaria verticillate, SETVE), poison ryegrass (Lolium temulentum, LOLTE) or hairy beggarsticks (Bidens pilosa, BIDPI or Galinsoga parviflora, GASPA).

In some embodiments, the combination of (a) oxyfluorfen and (b) haloxyfop or an agriculturally acceptable ester or salt thereof may be used to control herbicide resistant or tolerant weeds. The methods and the compositions described herein may also be employed to control herbicide resistant or tolerant weeds. Exemplary resistant or tolerant weeds include, but are not limited to, biotypes resistant or tolerant to acetolactate synthase (ALS) inhibitors, photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, multiple chemical classes, and multiple herbicide modes-of-action.

In some embodiments of the methods provided herein, the composition is applied at an application rate of from about 70 grams active ingredient per hectare (g ai/ha) to about 2500 g ai/ha based on the total amount of active ingredients in the composition. In certain embodiments, the composition is applied at an application rate of from about 162 g ai/ha to about 402 g ai/ha based on the total amount of active ingredients in the composition.

In some embodiments of the methods provided herein, oxyfluorfen is applied at an application rate of: from about 50 to about 2,000 g ai/ha; from about 50 to about 1,000 g ai/ha; from about 100 to about 1,000 g ai/ha; from about 100 to about 500 g ai/ha; or from about 200 to about 400 g ai/ha. In some embodiments of the methods provided herein, oxyfluorfen is applied at an application rate of: from about 50 to about 2,000 g ai/ha; from about 50 to about 1,000 g ai/ha; from about 100 to about 1,000 g ai/ha; from about 100 to about 560 g ai/ha; from about 100 to about 500 g ai/ha; or from about 100 to about 400 g ai/ha. In one embodiment, oxyfluorfen is applied at an application rate of from about 120 to about 360 g ai/ha. In one embodiment, oxyfluorfen is applied at an application rate of about 120 g ai/ha. In another embodiment, oxyfluorfen is applied at an application rate of about 240 g ai/ha. In yet another embodiment, oxyfluorfen is applied at an application rate of about 360 g ai/ha.

In some embodiments of the methods provided herein, haloxyfop, or an agriculturally acceptable ester or salt thereof (e.g., haloxyfop-methyl), is applied at an application rate of: from about 20 to about 500 g ai/ha; from about 30 to about 300 g ai/ha; from about 30 to about 200 g ai/ha; or from about 40 to about 100 g ai/ha. In one embodiment, haloxyfop, or an agriculturally acceptable ester or salt thereof (e.g., haloxyfop-methyl), is applied at an application rate of from about 42 to about 84 g ai/ha. In some embodiments of the methods provided herein, haloxyfop or an agriculturally acceptable ester or salt thereof (e.g., haloxyfop-methyl) is applied at an application rate of: from about 10 to about 500 g ai/ha; from about 20 to about 300 g ai/ha; from about 25 to about 200 g ai/ha; or from about 30 to about 150 g ai/ha. In one embodiment, haloxyfop or an agriculturally acceptable ester or salt thereof (e.g., haloxyfop-methyl) is applied at an application rate of from about 20 to about 150 g ai/ha. In one embodiment, haloxyfop or an agriculturally acceptable ester or salt thereof (e.g., haloxyfop-methyl) is applied at an application rate of from about 30 to about 120 g ai/ha. In one embodiment, haloxyfop or an agriculturally acceptable ester or salt thereof (e.g., haloxyfop-methyl) is applied at an application rate of about 42 g ai/ha.

In some embodiments of the methods provided herein, oxyfluorfen is applied at an application rate of from about 50 to about 2000 g ai/ha, and haloxyfop or an agriculturally acceptable ester or salt thereof (e.g., haloxyfop-methyl) is applied at an application rate of from about 20 to about 500 g ai/ha. In some embodiments of the methods provided herein, oxyfluorfen is applied at an application rate of from about 120 to about 360 g ai/ha, and haloxyfop, or an agriculturally acceptable ester or salt thereof (e.g., haloxyfop-methyl), is applied at an application rate of from about 42 to about 84 g ai/ha. In some embodiments of the methods provided herein, oxyfluorfen is applied at an application rate of from about 120 to about 360 g ai/ha, and haloxyfop or an agriculturally acceptable ester or salt thereof (e.g., haloxyfop-methyl) is applied at an application rate of from about 20 to about 150 g ai/ha. In one embodiment, oxyfluorfen is applied at an application rate of from about 120 to about 360 g ai/ha, and haloxyfop or an agriculturally acceptable ester or salt thereof (e.g., haloxyfop-methyl) is applied at an application rate of about 42 g ai/ha. In one embodiment, oxyfluorfen is applied at an application rate of about 120 g ai/ha, and haloxyfop or an agriculturally acceptable ester or salt thereof (e.g., haloxyfop-methyl) is applied at an application rate of about 42 g ai/ha. In another embodiment, oxyfluorfen is applied at an application rate of about 240 g ai/ha, and haloxyfop or an agriculturally acceptable ester or salt thereof (e.g., haloxyfop-methyl) is applied at an application rate of about 42 g ai/ha. In yet another embodiment, oxyfluorfen is applied at an application rate of about 360 g ai/ha, and haloxyfop or an agriculturally acceptable ester or salt thereof (e.g., haloxyfop-methyl) is applied at an application rate of about 42 g ai/ha.

The components of the mixtures described herein can be applied either separately or as part of a multipart herbicidal system.

The mixtures described herein can be applied in conjunction with one or more other herbicides to control a wider variety of undesirable vegetation. When used in conjunction with other herbicides, the composition can be formulated with the other herbicide or herbicides, tank mixed with the other herbicide or herbicides, or applied sequentially with the other herbicide or herbicides. Some of the herbicides that can be employed in conjunction with the compositions and methods described herein include, but are not limited to: 4-CPA, 4-CPB, 4-CPP, 2,4-D, 2,4-D choline salt, 2,4-D esters and amines, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, glufosinate, glufosinate-ammonium, glufosinate-P-ammonium, glyphosate salts and esters, halauxifen, halosafen, halosulfuron-methyl, haloxydine, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac-methyl, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfurn-methyl, thiobencarb, tiafenacil, tiocarbazil, tioclorim, topramezone, tralkoxydim, triafamone, tri-allate, triasulfuron, triaziflam, tribenuron, tribenuron-methyl, tricamba, triclopyr choline salt, triclopyr esters and amines, tridiphane, trietazine, trifloxysulfuron, trifluralin, triflusulfuron, trifop, trifopsime, trihydroxytriazine, trimeturon, tripropindan, tritac, tritosulfuron, vernolate, xylachlor, benzyl 4-amino-3-chloro-5-fluoro-6-(4-chloro-2-fluoro-3-methoxyphenyl)pyridine-2-carboxylate and salts, esters, optically active isomers and mixtures thereof.

In some embodiments, the compositions described herein are employed in combination with one or more herbicide safeners, such as AD-67 (MON 4660), benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, naphthalic anhydride (NA), oxabetrinil, 829148 and N-phenyl-sulfonylbenzoic acid amides, to enhance their selectivity. In some embodiments, the safeners are employed in rice, cereal, corn, or maize settings. In some embodiments, the safener is cloquintocet or an ester or salt thereof. In certain embodiments, cloquintocet is utilized to antagonize harmful effects of the compositions on rice and cereals. In some embodiments, the safener is cloquintocet (mexyl).

In some embodiments, compositions provided herein further comprise at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, and wettable powders, or liquids, such as, for example, emulsifiable concentrates, solutions, emulsions and suspensions. They can also be provided as a pre-mix or tank mixed.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

In some embodiments, the compositions described herein further comprise one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical Publishing Co., New York, 1980-81. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide additionproducts, such as nonylphenol-C₁₈ ethoxylate; alcohol-alkylene oxide addition products, such as tridecyl alcohol-C₁₆ ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

In some embodiments, these materials, such as vegetable or seed oils and their esters, can be used interchangeably as an agricultural adjuvant, as a liquid carrier or as a surface active agent.

Other exemplary additives for use in the compositions provided herein include, but are not limited to, compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

In some embodiments, the concentration of the active ingredients in the compositions described herein is from about 0.0005 to 98 percent by weight. In some embodiments, the concentration is from about 0.0006 to 90 percent by weight. In compositions designed to be employed as concentrates, the active ingredients, in certain embodiments, are present in a concentration from about 0.1 to 98 weight percent, and in certain embodiments about 0.5 to 90 weight percent. Such compositions are, in certain embodiments, diluted with an inert carrier, such as water, before application. The diluted compositions usually applied to weeds or the locus of weeds contain, in certain embodiments, about 0.007 to 8 weight percent active ingredient and in certain embodiments contain about 0.01 to 5.0 weight percent.

The present compositions can be applied to weeds or their locus by the use of conventional ground or aerial dusters, sprayers, and granule applicators, by addition to irrigation or paddy water, and by other conventional means known to those skilled in the art.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLES

### Example I

### Evaluation of Post-Emergence Herbicidal Activity of Mixtures Containing Oxyfluorfen and Haloxyfop-Methyl in the Onion Field

Multiple post-emergence field trials were conducted under field conditions in Colombia, Peru and Ecuador. Trial sites were located in commercially grown fields of onion (Allium spp) using standard herbicide small plot research methodology. Post-emergence trial plot size varied from 0.4 to 2 meter (m)×5 to 25 m (width×length) with 4 replicates per treatment. The onion crop was grown using normal cultural practices for fertilization, seeding, watering and maintenance to ensure good growth of the crop and the weeds.

All treatments in the post-emergence field trials were applied using a backpack compressed carbon dioxide (CO₂) sprayer with flat fan nozzles calibrated to apply 400 liters per hectare (L/ha) spray volume at approximately 35 pounds per square inch (psi) nozzle pressure. Commercially available products of oxyfluorfen (GOAL® 480SC 480 grams active ingredient per liter (g ai/L) and haloxyfop-methyl (VERDICT R® 42 g ai/L) were mixed in water at appropriate formulated product rates to achieve the desired rates based on a unit area of application (hectare). Treatments were rated at 7 to 31 days after application (DAA) as compared to the untreated control plants. Visual weed control was scored on a scale of 0 to 100 percent where 0 corresponds to no injury and 100 corresponds to complete kill.

All treatment results, both for the single product and mixtures, are an average of 4 replicates. The trial sites had naturally occurring populations of weeds. The weed spectrum included, but was not limited to, AMBEL, BIDPI, BRSRA, GASPA, ELEIN, LOLTE, POANN, and SETVE.

Colby's equation was used to determine the herbicidal effects expected from the mixtures (Colby, S. R. Calculation of the synergistic and antagonistic response of herbicide combinations. Weeds 1967, 15, 20-22.).

The following equation was used to calculate the expected activity of mixtures containing two active ingredients, A and B:

Expected=A+B−(A×B/100)

A=observed efficacy of active ingredient A at the same concentration as used in the mixture.

B=observed efficacy of active ingredient B at the same concentration as used in the mixture.

The compounds tested, application rates employed, plant species tested, and results from in-crop field trials are given in Tables 1-2. No crop injury to onions was seen with any treatment.

TABLE 1
Synergistic Activity of Foliar-Applied Oxyfluorfen
and Haloxyfop-methyl when evaluated 15 to 31 Days
After Application to Broadleaf Weeds in the Field.

| | | | Haloxyfop- | Visual | |
|---|---|---|---|---|---|
| | Days After | Oxyfluorfen | methyl | Control (%) | |
| Weed | Application | g ai/ha | g ai/ha | Obs | Exp |
| AMBEL | 15 | 120 | 0 | 21 | — |
| AMBEL | 15 | 240 | 0 | 22 | — |
| AMBEL | 15 | 360 | 0 | 22 | — |
| AMBEL | 15 | 0 | 42 | 6 | — |
| AMBEL | 15 | 120 | 42 | 42 | 26 |
| AMBEL | 15 | 240 | 42 | 43 | 27 |
| AMBEL | 15 | 360 | 42 | 44 | 27 |
| BIDPI | 16 | 120 | 0 | 49 | — |
| BIDPI | 16 | 240 | 0 | 56 | — |
| BIDPI | 16 | 360 | 0 | 69 | — |
| BIDPI | 16 | 0 | 42 | 0 | — |
| BIDPI | 16 | 120 | 42 | 76 | 49 |
| BIDPI | 16 | 240 | 42 | 87 | 56 |
| BIDPI | 16 | 360 | 42 | 96 | 69 |
| BIDPI | 31 | 120 | 0 | 54 | — |
| BIDPI | 31 | 240 | 0 | 61 | — |
| BIDPI | 31 | 360 | 0 | 69 | — |
| BIDPI | 31 | 0 | 42 | 0 | — |
| BIDPI | 31 | 120 | 42 | 69 | 54 |
| BIDPI | 31 | 240 | 42 | 83 | 61 |
| BIDPI | 31 | 360 | 42 | 95 | 69 |
| BRSRA | 16 | 120 | 0 | 70 | — |
| BRSRA | 16 | 240 | 0 | 74 | — |
| BRSRA | 16 | 360 | 0 | 85 | — |
| BRSRA | 16 | 0 | 42 | 0 | — |
| BRSRA | 16 | 120 | 42 | 90 | 70 |
| BRSRA | 16 | 240 | 42 | 95 | 74 |
| BRSRA | 16 | 360 | 42 | 99 | 85 |
| BRSRA | 31 | 120 | 0 | 74 | — |
| BRSRA | 31 | 240 | 0 | 79 | — |
| BRSRA | 31 | 360 | 0 | 86 | — |
| BRSRA | 31 | 0 | 42 | 0 | — |
| BRSRA | 31 | 120 | 42 | 88 | 74 |
| BRSRA | 31 | 240 | 42 | 94 | 79 |
| BRSRA | 31 | 360 | 42 | 99 | 86 |
| GASPA | 15 | 120 | 0 | 49 | — |
| GASPA | 15 | 240 | 0 | 47 | — |
| GASPA | 15 | 360 | 0 | 45 | — |
| GASPA | 15 | 0 | 42 | 6 | — |
| GASPA | 15 | 120 | 42 | 85 | 52 |
| GASPA | 15 | 240 | 42 | 88 | 50 |
| GASPA | 15 | 360 | 42 | 93 | 48 |

AMBEL = common ragweed (Ambrosia artemisiifolia L.)
BIDPI = hairy beggarticks (Bidens pilosa)
BRSRA = birdsrape mustard (Brassica rapa)
GASPA = smallflower galinsoga (Galinsoga parviflora)
g ai/ha = grams active ingredient per hectare
Obs = Observed Percent (%) Visual Weed Control in the field
Exp = Expected Percent (%) Visual Weed Control value as calculated by Colby's equation
Days After Application = the number of days from treatment to visual evaluation

TABLE 2
Synergistic Activity of Foliar-Applied Oxyfluorfen
and Haloxyfop-methyl when evaluated 15 to 31 Days
After Application to Grass Weeds in the Field.

| | | | Haloxyfop- | Visual | |
|---|---|---|---|---|---|
| | Days After | Oxyfluorfen | methyl | Control (%) | |
| Weed | Application | g ai/ha | g ai/ha | Obs | Exp |
| ELEIN | 7 | 360 | 0 | 47 | — |
| ELEIN | 7 | 0 | 42 | 6 | — |
| ELEIN | 7 | 360 | 42 | 81 | 50 |
| LOLTE | 15 | 120 | 0 | 21 | — |
| LOLTE | 15 | 240 | 0 | 22 | — |
| LOLTE | 15 | 360 | 0 | 22 | — |
| LOLTE | 15 | 0 | 42 | 4 | — |
| LOLTE | 15 | 120 | 42 | 42 | 25 |
| LOLTE | 15 | 240 | 42 | 42 | 26 |
| LOLTE | 15 | 360 | 42 | 44 | 26 |
| POAAN | 15 | 120 | 0 | 45 | — |
| POAAN | 15 | 240 | 0 | 45 | — |
| POAAN | 15 | 360 | 0 | 47 | — |
| POAAN | 15 | 0 | 42 | 5 | — |
| POAAN | 15 | 120 | 42 | 65 | 48 |
| POAAN | 15 | 240 | 42 | 71 | 48 |
| POAAN | 15 | 360 | 42 | 81 | 49 |
| SETVE | 7 | 360 | 0 | 70 | — |
| SETVE | 7 | 0 | 42 | 77 | — |
| SETVE | 7 | 360 | 42 | 100 | 93 |

ELEIN = goosegrass (Eleusine indica)
LOLTE = poison ryegrass (Lolium temulentum)
POANN = annual bluegrass (Poa annua L.)
SETVE = bristly foxtail (Setaria verticillata)
g ai/ha = grams active ingredient per hectare
Obs = Observed % Visual Weed Control in the field
Exp = Expected % Visual Weed Control value as calculated by Colby's equation
Days After Application = the number of days from treatment to visual evaluation

Further provided herein are the following embodiments:

1. A method of synergistically controlling undesirable vegetation in crop and non-crop areas which comprises contacting the vegetation or the locus thereof with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof.
2. A method of synergistically controlling undesirable vegetation in crop and non-crop areas which comprises contacting the vegetation or the locus thereof with, or applying to the soil or water to prevent the emergence or growth of vegetation, a herbicidally effective amount of (a) oxyfluorfen and (b) haloxyfop or an agriculturally acceptable ester or salt thereof.
3. The method of embodiment 1 or embodiment 2, wherein the weight ratio of oxyfluorfen to haloxyfop or an agriculturally acceptable ester or salt thereof is from about 1:3 to about 100:1.
4. A method of controlling undesirable vegetation which comprises contacting the vegetation or the locus thereof with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is from about 1:3 to about 100:1.
5. The method of embodiment 4, wherein the undesirable vegetation is controlled in direct-seeded, water-seeded and transplanted rice, wheat, barley, oats, rye, sorghum, soybean, green bean, garbanzo bean, corn/maize, cotton, pastures, grasslands, rangelands, fallowland, fallow-bed prior to planting crops, tree, vine and fruit orchards, including, but not limited to, citrus, grapes, almond, apple, apricot, avocado, beechnut, Brazil nut, butternut, cashew, cherry, chestnut, chinquapin, crab apple, date, feijoa, fig, filbert, hickory nut, kiwi, loquat, macadamia nut, mayhaws, nectarine, olives, peach, pear, pecan, persimmon, pistachio, plum, pomegranates, prune, quince, and walnut; vegetables (e.g., onions, onions grown for seed, shallots, garlic, peppers, tomatoes, artichokes and cole crops); fruiting crops (e.g., blueberries, guava, papaya, strawberries, taro, blackberries and raspberries); perennial crops, plantation crops (including, but not limited to, coffee, cacao, rubber and palm oil) and non-crop (including turf, forestry, aquatics, industrial vegetation management, deciduous trees, conifers (seedbeds, transplants, container stock and plantations/windbreaks), fencerows, parking areas, tank farm and storage areas, rights-of-way and utility areas).
6. A method of controlling undesirable vegetation in onion which comprises contacting the vegetation or the locus thereof with, or applying to the soil to prevent the emergence or growth of vegetation, a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is from about 1:3 to about 100:1.
7. The method of any one of embodiments 1-6, wherein oxyfluorfen and haloxyfop or an agriculturally acceptable ester or salt thereof are applied at an application rate of from about 70 grams active ingredient per hectare (g ai/ha) to about 2500 g ai/ha based on the total amount of active ingredients in the composition.
8. The method of any one of embodiments 1-7, wherein oxyfluorfen and haloxyfop or an agriculturally acceptable ester or salt thereof are applied at an application rate of from about 162 grams active ingredient per hectare (g ai/ha) to about 402 g ai/ha based on the total amount of active ingredients in the composition.
9. The method of any one of embodiments 1-8, wherein oxyfluorfen is applied at an application rate of from about 50 to about 2000 g ai/ha, and haloxyfop or an agriculturally acceptable ester or salt thereof is applied at an application rate of from about 20 to about 500 g ai/ha.
10. The method of any one of embodiments 1-9, wherein oxyfluorfen is applied at an application rate of from about 120 to about 360 g ai/ha, and haloxyfop or an agriculturally acceptable ester or salt thereof is applied at an application rate of from about 20 to about 150 g ai/ha.
11. The method of any one of embodiments 1-10, wherein oxyfluorfen is applied at an application rate of from about 120 to about 360 g ai/ha, and haloxyfop or an agriculturally acceptable ester or salt thereof is applied at an application rate of about 42 to about 84 g ai/ha.
12. The method of any one of embodiments 1-11, wherein the undesirable vegetation is common ragweed (Ambrosia artemisiifolia L., AMBEL), birdsrape mustard (Brassica rapa, BRSRA), goosegrass (Eleusine indica, ELEIN), annual bluegrass (Poa annua, POAAN), bristly foxtail (Setaria verticillata, SETVE), poison ryegrass (Lolium temulentum, LOLTE), or hairy beggarsticks (Bidens pilosa, BIDPI or Galinsoga parviflora, GASPA).
13. The method of any one of embodiments 1-12, wherein the agriculturally acceptable ester of haloxyfop is haloxyfop-methyl or haloxyfop-P-methyl.
14. The method of any one of embodiments 1-13, wherein the (a) oxyfluorfen and (b) haloxyfop or an agriculturally acceptable ester or salt thereof are applied to water.
15. The method of any one of embodiments 1-13, wherein the (a) oxyfluorfen and (b) haloxyfop or an agriculturally acceptable ester or salt thereof are applied pre-emergently.
16. The method of any one of embodiments 1-13, wherein the (a) oxyfluorfen and (b) haloxyfop or an agriculturally acceptable ester or salt thereof are applied post-emergently.
17. A herbicidal composition comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is from about 1:3 to about 100:1.
18. The composition of embodiment 17, wherein the weight ratio of oxyfluorfen to haloxyfop or an agriculturally acceptable ester or salt thereof is about 3:1 to about 9:1
19. The composition of embodiment 17 or embodiment 18, wherein the agriculturally acceptable ester of haloxyfop is a methyl ester.
20. The composition of any one of embodiments 17-19, further comprising a herbicide safener.
21. The composition of any one of embodiments 17-20, further comprising an agriculturally acceptable adjuvant or carrier.
22. The composition of any one of embodiments 17-21, which is synergistic as determined by the Colby equation.

1-22. (canceled)

23. A method of synergistically controlling undesirable vegetation in crop and non-crop areas which comprises contacting the vegetation or the locus thereof with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof.

24. A method of synergistically controlling undesirable vegetation in crop and non-crop areas which comprises contacting the vegetation or the locus thereof with, or applying to the soil or water to prevent the emergence or growth of vegetation, a herbicidally effective amount of (a) oxyfluorfen and (b) haloxyfop or an agriculturally acceptable ester or salt thereof.

25. The method of claim 23, wherein the weight ratio of oxyfluorfen to haloxyfop or an agriculturally acceptable ester or salt thereof is from about 1:3 to about 100:1.

26. A method of controlling undesirable vegetation which comprises contacting the vegetation or the locus thereof with, or applying to the soil or water to prevent the emergence or growth of vegetation, a herbicidal composition comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is from about 1:3 to about 100:1.

27. The method of claim 26, wherein the undesirable vegetation is controlled in direct-seeded, water-seeded and transplanted rice, wheat, barley, oats, rye, sorghum, soybean, green bean, garbanzo bean, corn/maize, cotton, pastures, grasslands, rangelands, fallowland, fallow-bed prior to planting crops, tree, vine and fruit orchards, including, but not limited to, citrus, grapes, almond, apple, apricot, avocado, beechnut, Brazil nut, butternut, cashew, cherry, chestnut, chinquapin, crab apple, date, feijoa, fig, filbert, hickory nut, kiwi, loquat, macadamia nut, mayhaws, nectarine, olives, peach, pear, pecan, persimmon, pistachio, plum, pomegranates, prune, quince, and walnut; vegetables (e.g., onions, onions grown for seed, shallots, garlic, peppers, tomatoes, artichokes and cole crops); fruiting crops (e.g., blueberries, guava, papaya, strawberries, taro, blackberries and raspberries); perennial crops, plantation crops (including, but not limited to, coffee, cacao, rubber and palm oil) and non-crop (including turf, forestry, aquatics, industrial vegetation management, deciduous trees, conifers (seedbeds, transplants, container stock and plantations/windbreaks), fencerows, parking areas, tank farm and storage areas, rights-of-way and utility areas).

28. The method of claim 26, wherein the undesirable vegetation is controlled in onion.

29. A method of controlling undesirable vegetation in onion which comprises contacting the vegetation or the locus thereof with, or applying to the soil to prevent the emergence or growth of vegetation, a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is from about 1:3 to about 100:1.

30. The method of claim 23, wherein oxyfluorfen and haloxyfop or an agriculturally acceptable ester or salt thereof are applied at an application rate of from about 70 grams active ingredient per hectare (g ai/ha) to about 2500 g ai/ha based on the total amount of active ingredients in the composition.

31. The method of claim 23, wherein oxyfluorfen and haloxyfop or an agriculturally acceptable ester or salt thereof are applied at an application rate of from about 162 grams active ingredient per hectare (g ai/ha) to about 402 g ai/ha based on the total amount of active ingredients in the composition.

32. The method of claim 23, wherein oxyfluorfen is applied at an application rate of from about 50 to about 2000 g ai/ha, and haloxyfop or an agriculturally acceptable ester or salt thereof is applied at an application rate of from about 20 to about 500 g ai/ha.

33. The method of claim 23, wherein oxyfluorfen is applied at an application rate of from about 120 to about 360 g ai/ha, and haloxyfop or an agriculturally acceptable ester or salt thereof is applied at an application rate of from about 20 to about 150 g ai/ha.

34. The method of claim 23, wherein oxyfluorfen is applied at an application rate of from about 120 to about 360 g ai/ha, and haloxyfop or an agriculturally acceptable ester or salt thereof is applied at an application rate of about 42 to about 84 g ai/ha.

35. The method of claim 23, wherein the undesirable vegetation is common ragweed (Ambrosia artemisiifolia L., AMBEL), birdsrape mustard (Brassica rapa, BRSRA), goosegrass (Eleusine indica, ELEIN), annual bluegrass (Poa annua, POAAN), bristly foxtail (Setaria verticillata, SETVE), poison ryegrass (Lolium temulentum, LOLTE), or hairy beggarsticks (Bidens pilosa, BIDPI or Galinsoga parviflora, GASPA).

36. The method of claim 23, wherein the agriculturally acceptable ester of haloxyfop is haloxyfop-methyl or haloxyfop-P-methyl.

37. The method of claim 23, wherein the (a) oxyfluorfen and (b) haloxyfop or an agriculturally acceptable ester or salt thereof are applied to water.

38. The method of claim 23, wherein the (a) oxyfluorfen and (b) haloxyfop or an agriculturally acceptable ester or salt thereof are applied pre-emergently.

39. The method of claim 23, wherein the (a) oxyfluorfen and (b) haloxyfop or an agriculturally acceptable ester or salt thereof are applied post-emergently.

40. A herbicidal composition comprising a herbicidally effective amount of (a) oxyfluorfen and (b) haloxyfop or an agriculturally acceptable ester or salt thereof, wherein the weight ratio of oxyfluorfen to haloxyfop or an agriculturally acceptable ester or salt thereof is from about 1:3 to about 100:1.

41. The composition of claim 40, wherein the weight ratio of oxyfluorfen to haloxyfop or an agriculturally acceptable ester or salt thereof is about 3:1 to about 9:1.

42. The composition of claim 40, wherein the agriculturally acceptable ester of haloxyfop is a methyl ester.

43. The composition of claim 40, further comprising a herbicide safener.

44. The composition of claim 40, further comprising an agriculturally acceptable adjuvant or carrier.

45. The composition of claim 40, which is synergistic as determined by the Colby equation.
